(19) United States
(12) Patent Application Publication
(10) Pub. No.: US 2012/0116911 A1
(43) Pub. Date: May 10, 2012

(54) Data Valuation Estimates in Online Systems

(75) Inventors: Dwight A. Irving, Lebanon, NJ (US); Thomas C. Wilson, II, Randolph, NJ (US); Eliot Bergson, New York, NY (US); Cameron Lewis, Woodland, CA (US)

(73) Assignee: STATZ, INC., Great Neck, NY (US)

(21) Appl. No.: 12/942,884

(22) Filed: Nov. 9, 2010

(51) Int. Cl. G06Q 30/00; G06F 15/16

(52) U.S. Cl. 705/26.4; 709/217

(57) ABSTRACT

A request for a valuation of a data set is received, over a network, from a requesting user. A plurality of valuation elements associated with the data set are identified, using a data processing system. A data valuation estimate is determined, using the data processing system, for the data set using the plurality of valuation elements. A representation of the data valuation estimate is transmitted, over the network, to the requesting user such that the representation of the data valuation estimate is caused to be displayed on a display device associated with the requesting user.

### CROSS-REFERENCE TO RELATED APPLICATIONS

The present application relates to the subject matter of U.S. patent application Ser. No. 12/848,015, filed Jul. 30, 2010, entitled “Online Marketplace for Trading of Data Collected from Use of Products and Services,” the disclosure of which is hereby incorporated herein by reference in its entirety.

### FIELD OF THE TECHNOLOGY

At least some embodiments disclosed herein relate to online marketplaces for trading of data in general, and more particularly, but not limited to, online marketplaces for trading of data that estimate the value of such data using multiple factors relating to the data, including privacy risk metrics.

### BACKGROUND

Various methods exist for collecting data relating to individuals or entities. Such methods could include, for example, data collected via sensors embedded in physical objects (e.g., personal communication devices like mobile phones or other forms of consumer products like bicycles or kitchen appliances such as microwave ovens, or even business products such as farming equipment). Such methods also could include data collected via data uploads. Such data file uploads could include document, spreadsheets, or XML files. Such data could be directly uploaded by an individual to a server, or could be retrieved from a service provider, such as an individual's bank or phone company.

Data relating to an individual can have value. Many businesses and other entities may be interested in data relating to, for example, consumer's activities and purchases, the financial condition of individuals or groups of individuals, the health of individuals or groups of individuals. Some businesses or other entities may be willing to pay for such data, and some individuals may be willing to sell such data. The valuation of such data in the marketplace can entail many considerations, including the risk that a data seller's privacy may be compromised through sale of such data.

### SUMMARY OF THE DESCRIPTION

Systems and methods to provide for estimating the valuation of a data seller's data in a data marketplace are disclosed below. Some embodiments are summarized in this section.

In one embodiment, a request for a valuation of a data set received from a data seller is received, over a network, from a requesting user. A plurality of valuation elements associated with the data set are identified using a data processing system. A data valuation estimate is determined, using the data processing system, for the data set using the plurality of valuation elements. A representation of the data valuation estimate is transmitted, over the network, to the requesting user such that the representation of the data valuation estimate is caused to be displayed on a display device associated with the requesting user.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to trade data using an online marketplace according to one embodiment.

FIG. 2 shows a system for collecting user data using sensors according to one embodiment.

FIG. 3 shows an example of a user interface used by a data buyer to search for selected user data in an online marketplace for potential purchase in a trade transaction according to one embodiment.

FIG. 4 shows an example of a user interface used by an end user to register data sources and upload user data to an online marketplace according to one embodiment.

FIG. 5 shows an embodiment of a process where a privacy risk metric could be determined and used within an online data marketplace.

FIG. 6 shows an embodiment of a process where a data valuation estimate could be determined and used within an online data marketplace.

FIG. 7 shows a block diagram of a data processing system which can be used in various embodiments.

FIG. 8 shows a block diagram of a user device according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, “marketplace” means a trading exchange or other data or computer system (e.g., a hosted website) that is electronically available to or accessible by buyers and/or sellers (e.g., over the Internet or by another online or networked form of access, or by wired or wireless access) for trading (e.g., purchasing or leasing of sets or groups of data). The buyers and sellers do not need to each access the marketplace at the same time or during the same session.

At least some embodiments discussed below provide for the estimation of the value of a data seller's data relating in a marketplace for the trading of data.

### An Illustrative Embodiment of a Data Marketplace

In one embodiment, a web server is used to host a marketplace for the trading of data provided from a plurality of data sellers. User data is collected from each of the data sellers. The respective user data includes data obtained from the use by each respective data seller of a product and/or a service. In one embodiment, the marketplace can include a seller user interface which could include a meter or other user interface element to express to the data seller a value of the user data obtained relating to a product and/or service. In one embodiment, the meter value is dynamic. Factors that influence the calculation of value can include how much data a user elects to collect and store, the historical behavior of sales of data from the particular data source, the historical behavior of other users of this particular data source, amount of other personal characteristics elected by the user to be released for sale in the marketplace, the level of participation by the user in data reports, the combination of data sources registered by the user, the association of the data with a product or products, preference data, and so forth. The collected user data is stored (e.g., in a database accessible by the web server). In some embodiments, the database is stored on separate computer systems accessible by the marketplace (e.g., a network cloud or distributed storage network).

The marketplace is used to offer the user data from one or more of the data sellers for a trade with a data buyer e.g., a data buyer accessing the marketplace over the Internet. If the data buyer accepts the trade (e.g., as indicated by a clicking of a mouse in a user interface to confirm a proposed transaction to purchase a one-time or periodical data report or data profile), a copy of the user data (e.g., the data of one or more end users) is provided to the data buyer by the marketplace or alternatively from another computer system authorized by the marketplace to provide the data to the data buyer). Such computer systems could include the data seller's own computer. For example, in one embodiment, the system could be implemented as a peer-to-peer service where the data seller's computers retain the data, while the marketplace serves as an indexing and search service and processes buyer to seller transactions, and where data is transferred directly from the data seller to the data buyer.

Compensation is provided to each data seller based on a share of the revenue received from data buyers for access to the data seller's data. The share of revenue provided to each data seller (e.g., via the marketplace) may be based on the extent and/or type of user data provided to the data buyer. In one embodiment, the user data includes data obtained from use by each respective end user of the product, and the method further includes receiving an identification of one or more products (e.g., the product type, the model, manufacturer or brand, the serial number, and/or other product related information) from the respective data seller prior to the collecting of the respective user data, and associating the respective user data with the identification of the product. Note that in some embodiments, a dataset can relate to more than one product. For example, a bicycle frame, the bicycle wheels, tires, crank, derailleurs, brakes, seat, handlebars, etc. can all be from different manufacturers, but working together as a whole, with individual contributions to overall performance.

In one embodiment, the respective user data is associated with data regarding behavior of the respective end user (e.g., manners in which the product is used by the respective user). In one embodiment, as a matter of convenience, such information can be entered and associated with the data after the data is uploaded. These varied associations can provide the basis for valuing the collected data and product information. In some embodiments, user data is collected from many data sellers and then aggregated and stored for access by the marketplace. Data reports purchased by data buyers may include data collected from a number of different end users.

In another embodiment, the product is a user device comprising a communication device and a position identification unit to provide location data. The method includes receiving, from the communication device, the location data, and further associating the respective user data with the location data.

In other embodiments, data relating to usage by each respective end user of a third-party service is collected by the marketplace. The usage of the third-party service may be, for example, one or more of the following: website usage, utility service usage, credit card usage, bank account usage, mortgage account usage, and cell phone usage. The data regarding the respective end user may be collected from a plurality of third-party websites, and this data is associated with the respective user data of the particular user that has used the service. These data associations may be stored in a database accessible by the marketplace

In one embodiment, the respective user data includes data obtained from use by the first end user of a product, and the method further includes receiving an identification of the product from the first end user; associating the respective user data of the first end user with the product; collecting data relating to usage by the first end user of a third-party service for the product; and further associating respective user data of the first end user with the data relating to usage of the third-party service. In one embodiment, the respective user data of the first end user includes data collected by one or more sensors that monitor a product used by the first end user.

In another embodiment, the method further includes providing access to a data taxonomy for data buyers of the marketplace. The taxonomy includes a plurality of categories or markets (e.g., speed, temperature, average heart rate, date) corresponding to user data obtained from many end users (e.g., there could be 5-10, hundreds, or thousands or more end users that provide data to the marketplace). The markets may be related, for example, to environmental or product conditions or characteristics associated with or existing during the time of the data collection by the sensors. The user data is then made available for purchase through the marketplace to one or more online data buyers. In one embodiment, the plurality of markets include at least one of personal characteristics of a person and behavioral characteristics of a person.

As an example of product usage location, a product may be used in a business, residence, or other structure or asset owned by an entity, and user data obtained for that location. User data may come from sources as diverse as manufacturing sensors, university research data and odometers mounted on bicycles. In some embodiments, the product usage location can be dynamic. For example, in data originating from a cycling computer with a GPS-enabled device, the product usage location is dynamic and becomes part of the data set itself. Location data can be provided in any suitable format, such as, for example, as a set of coordinates—latitude/longitude/elevation—with respect to time, or as an address or a zip code.

In further embodiments, the method further includes assigning a price to a set of user data collected from end users, and presenting the price to data buyers visiting the marketplace when offering the user data for trade.

In other embodiments, the method further includes receiving a definition of a data level from each respective end user, the data level defining the forms of data for collection from the respective end user. The data level may indicate the extent of and type of data that the end user authorizes to be collected.

In one embodiment, a data buyer user interface is provided. The method further includes providing, via the marketplace, a user interface to a plurality of data buyers. The user interface is configured to present to each respective data buyer, for example, one or more of the following: a plurality of data categories for selection by the respective data buyer, and a menu of demographic categories for selection by the respective data buyer. The method further includes, after the selection by the respective data buyer of at least one of the data categories and of at least one of the demographic categories, providing, via the marketplace, a price for a data report for purchase by the data buyer.

In one embodiment, the data report includes the respective user data of the first end user, and the method further comprises receiving the revenue for the trade from the data buyer in exchange for the data report. In one embodiment, the method further includes providing the data report to the data buyer in the form of a plurality of periodic reports sent over time, and receiving the revenue in the form of a series of payments from the data buyer, each of the series of payments corresponding to one of the periodic reports. In one embodiment, the method further includes providing the data report to the data buyer, and the data report includes user data from each of the plurality of end users.

In other embodiments, the data report or other data set provided to a data buyer is a fixed form and fixed use report, an index or aggregation of data in a predetermined format, or a continuing stream of data. In one embodiment, the marketplace periodically sends a portion of the stream of data to the data buyer.

In one embodiment, a data processing system includes: (a) memory to store user data for a plurality of end users; and (b) one or more processors (e.g., a microprocessor or microcontroller, or multiple processors on a single chip) configured to: host a marketplace for trading of data provided from the plurality of end users; collect respective user data from each respective end user of the plurality of end users, the respective user data comprising data obtained from use by the respective end user of at least one of a product and a service; offer the respective user data of each respective end user for a trade with a first data buyer; if the first data buyer accepts the trade, provide the respective user data of a first end user to the first data buyer; and provide compensation to the first end user based on a share of the revenue received for the trade.

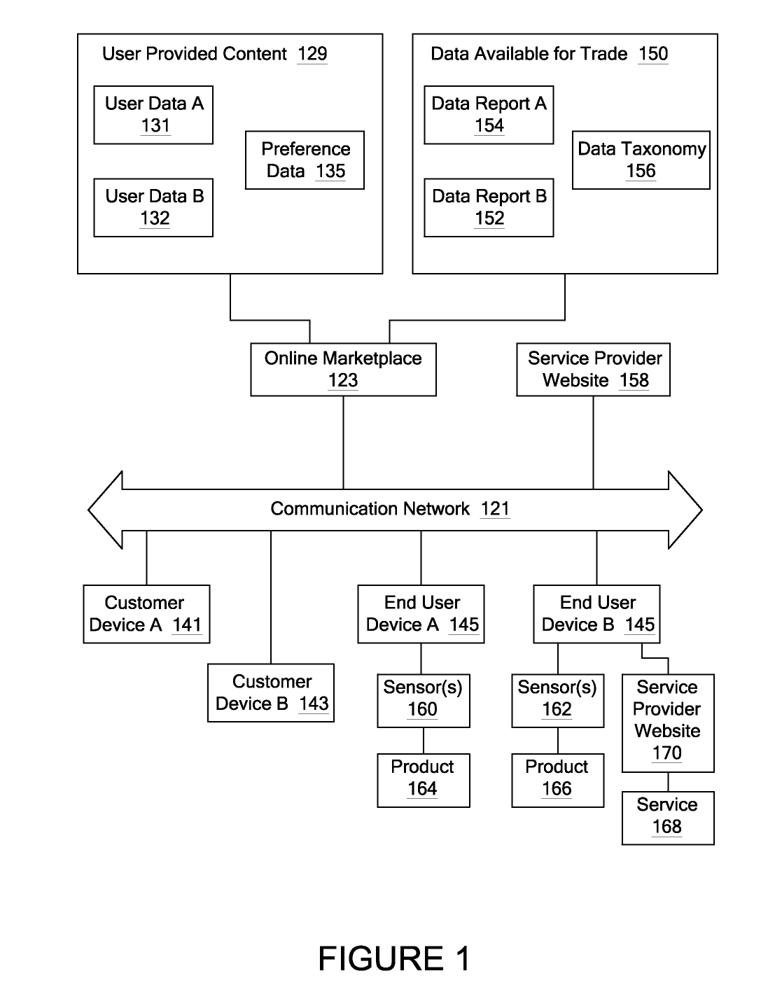

FIG. 1 shows a system to trade data (e.g., user data collected by sensors from end users) using an online marketplace 123 according to one embodiment. In FIG. 1, the end user devices 145 are used to access online marketplace 123 over a communication network 121. The online marketplace 123 may include one or more web servers (or other types of data communication servers) to communicate with the end user devices 145.

The online marketplace 123 is connected to a data storage facility to store user provided content 129, such as user data 131, 132 and end user preference data 135 (e.g., preference data may record customization information regarding an end user's desired or normal interaction with the marketplace 123). Data buyers access the marketplace 123 using data buyer devices 141, 143 where, in at least one embodiment, the user is presented with a user interface that indicates the value associated with preference data and customization information to specify a user's interaction with the marketplace.

In one embodiment, data buyers and sellers must go through a registration process to access and use marketplace 123. For example, an end user agreement may be presented to an end user (e.g. a data buyer or seller), and consent to the agreement from the end user required prior to the end user being granted access to marketplace 123.

In one embodiment, the user preference data 135 is configurable, pluggable, and tunable by the user via a user interface that includes a dynamic representation of value. For example, the user may select a set of criteria from a set of pre-defined criteria, or add a custom designed criterion, or adjust the parameters of the selected criteria. Thus, the users can configure the user data collection and/or uploading process as desired by a particular user.

In one embodiment, the user device 145 may be used to create user data in the form of still or video images of a product usage, which may be tagged with location data from the device. For example, in one embodiment, the user device includes a digital still picture camera, or a digital video camera. In such an embodiment, such images can be tagged with navigation data in an automated way.

Although FIG. 1 illustrates an example system implemented in client server architecture, embodiments of the disclosure can be implemented in various alternative architectures. For example, the online marketplace may be implemented via a peer to peer network of client devices or virtual servers and data stores hosted in a cloud-based environment.

In some embodiments, a combination of client server architecture and peer to peer architecture can be used, in which one or more centralized server may be used to provide some of the information and/or services and the peer to peer network is used to provide other information and/or services. Thus, embodiments of the disclosure are not limited to a particular architecture.

In one embodiment, online marketplace 123 may access user data on a service provider website 158 using communication network 121. This user data may be data from invoices or other records that reflect the use by the end user of a service provided, hosted or monitored by or from website 158.

More specifically, online marketplace 123 communicates with end user devices 145 (end user device A and end user device B) to permit each respective end user (of typically many end users) to upload user data to marketplace 123. End user device A may be coupled to one or more sensors 160, which are used to collect data sensed from the operation of a product 164 (e.g., a bicycle) by the user of end user device A.

Sensors 162 may be coupled to or integrated into end user device B. Sensors 162 may sense operating characteristics or conditions, or the output, of a product 166 in order to obtain user data. The data collected by sensors 162 is communicated to end user device B, which may then communicate the data to marketplace 123.

Service provider website 170 may be used to provide a service 168 to the user of end user device B (e.g., a cell phone or data service). Data associated with the use of service 168 may be downloaded to or collected by end user device B, and then sent to marketplace 123. This data also may be directly uploaded to online marketplace 123 from website 170.

In other embodiments, user data associated with product or service use by the user (e.g., a consumer) of end user device B may be uploaded directly from other computer systems (e.g., other client devices), cell phones or other mobile devices, and distributed networks. Data from all of these sources may be used to create user data or user profiles associated with a specific identified user, and all such data may be collected and stored by marketplace 123.

User provided content 129 includes user data A and user data B (131, 132) that has been uploaded or otherwise obtained by marketplace 123. User data A is data that has been collected from end user device A, or is otherwise associated with end user device A. Similarly, user data B has been collected from, or is otherwise associated with, end user device B. For example, user data B may be collected by marketplace 123 from service provider website 158, which may provide a service to end user device B. Thus, user data B may be associated with end user device B, although user data B is not collected directly from end user device B. Preference data 135 may be stored to reflect customized preferences of each end user when uploading data to or otherwise using or interacting with marketplace 123.

Online marketplace 123 makes collected data available for trade to one or more data buyers. Each such data buyer may use, for example, data buyer device A or data buyer device B to access marketplace 123. Data available for trade 150 may include one or more data reports 152 and 154 (data reports A and B). Data reports A and B may be formed by collecting various types of data from various end users. A data buyer may specify the type of data desired for a data report.

The marketplace 123 may store user data such that it is associated with one or more data categories or markets (e.g., speed, date, and time). These data categories or markets may be structured into a data taxonomy 156, for example, stored at or accessible by marketplace 123. A data buyer may use an Internet user interface (e.g., a webpage on a website) to select various desired data categories. The marketplace 123 then may offer data reports matching the desired categories for sale to the data buyer. In one embodiment, the data buyer may specify the desired data categories in advance of the collection of the user data from users. Marketplace 123 may communicate the desired data categories to end users, who may then authorize collection of such user data for use in preparing the data report for trade. The marketplace 123 may also automatically create the data report by collecting appropriate user data from end users (e.g., as such data collection may have been previously authorized by end users).

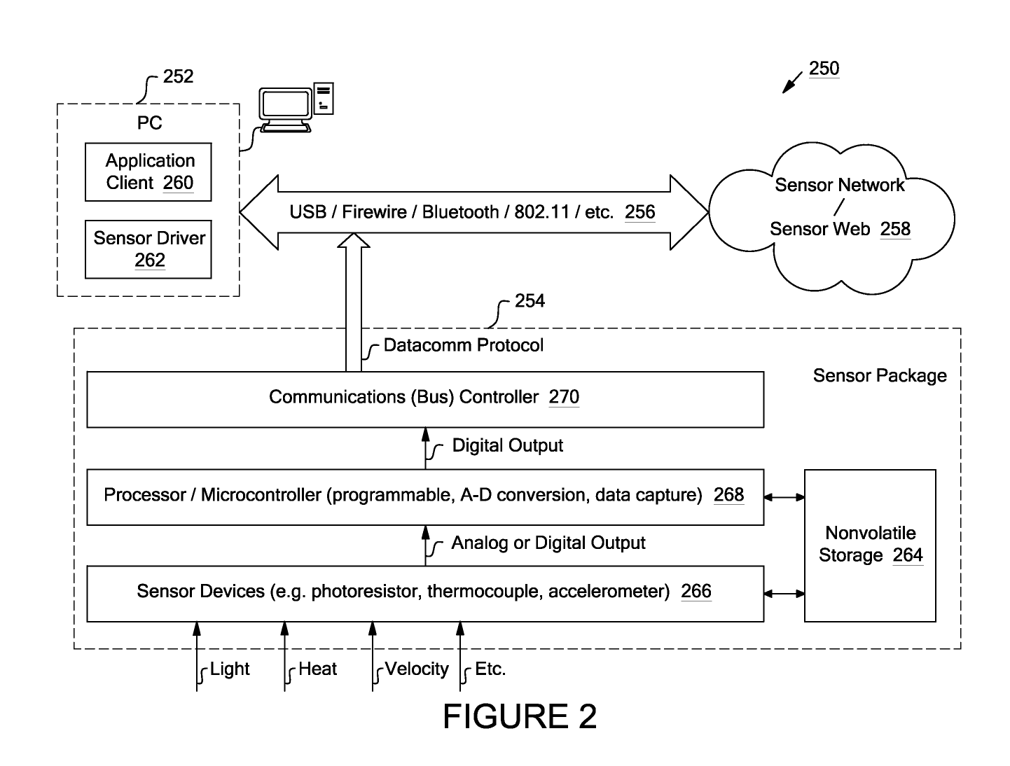

FIG. 2 shows a system 250 for collecting user data using sensors according to one embodiment. System 250 may be used to collect user data using various sensor devices or sensors 266 included in a sensor package 254. Sensors 266 may include, for example, a photoresistor, thermocouple, or accelerometer.

The collected sensor data may be communicated using a communications protocol 256 (e.g., USB, Firewire, Bluetooth, 802.11, RFID, etc.) to an end user device 252. End user device 252 may communicate with the marketplace 123 over communication network 121.

An application client 260 and a sensor driver 262 are installed and execute on end user device 252. The collected sensor data may be processed by application client 260 to provide user data for uploading. Communications protocol 256 is further implemented to communicate with a sensor network or sensor web 258 (e.g., which may provide yet further user data to end user device 252, for data collection and eventual uploading to marketplace 123).

Sensor package 254 further includes a microprocessor or microcontroller 268 that controls sensing and/or collection of data by the sensor devices 266. A communications controller 270 couples sensor package 254 to communications protocol 256. Software processes executed by processor 268 for sensing and data collection may be stored on a non-volatile storage device 264.

In one example, data is collected for solar panel usage by a company (i.e., the end user is the company). In this example, data is captured from energy monitors/sensors for solar panel output. The data collection is remote from the solar panel (i.e., the device/product), but data is recorded for the solar panel product performance.

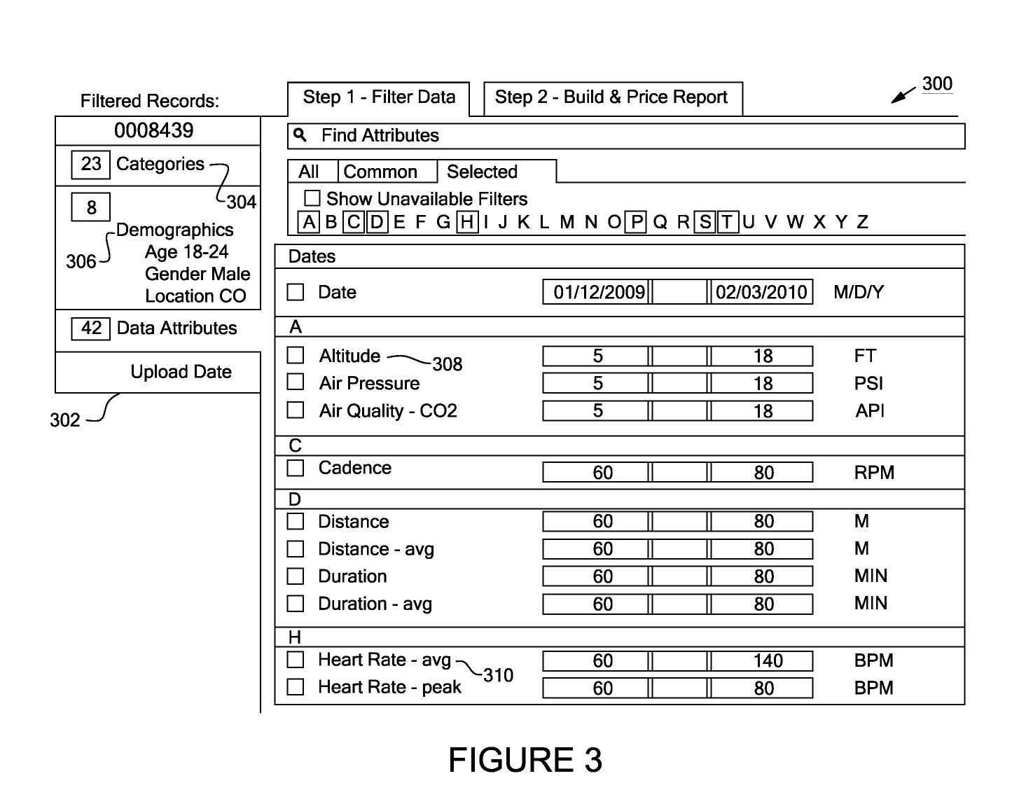

FIG. 3 shows an example of a user interface 300 used by a data buyer to search for selected user data in online marketplace 123 for potential purchase of a data report or other set of data in a trade transaction according to one embodiment. User interface 300 includes numerous forms of data categories 302 displayed to the data buyer (e.g., on a display of data buyer device 141 or 143). These data categories 302 may include demographic categories 306 (e.g., age, gender, or location) and other data categories 304. Examples of data categories 304 include altitude 308 and average heart rate 310 as illustrated in FIG. 3. Other forms of data categories 302 may include upload date, calendar date of product usage, and/or season or time of data collection.

The data buyer may select particular data categories using menus and/or clicking or activating various listed categories in the user interface. Data reports may then be assembled or located based on the data categories. Data taxonomy 156 may be used as the basis for presenting the categories to the data buyer.

In one embodiment, after a data report is defined or built based on selected data categories 302, marketplace 123 may determine a price to associate with the data report. The price is offered to the data buyer as a potential trade. End users receive compensation if a trade is completed based on the extent to which each end user's data is provided or used in the data report. The data report may be provided to a data buyer as a spreadsheet download including all of the data in the data buyer's search criteria.

In other embodiments, the user interface 300 could include additional interface elements (not shown) that allow the user to adjust the resolution of data displayed in the data report. For example, in the case of average heart rate 310, the data could be displayed, at the highest level of resolution, as a precise heart rate. At lower levels of resolution, the data could be represented as a set of ranges, for example, 60-80, 81-100, 101-120 and 121-140 BPM, or 60-80 and 81-140 BPM. Data sellers may ask a higher price for data at higher levels of resolution, since data at a higher resolution may have more of a tendency to place the data seller's privacy at risk. In the example above, a data seller may not mind disclosing an average heart rate above 80 BPM, but may not wish to disclose an average heart rate of 138 BPM unless a data buyer pays a higher price for the data.

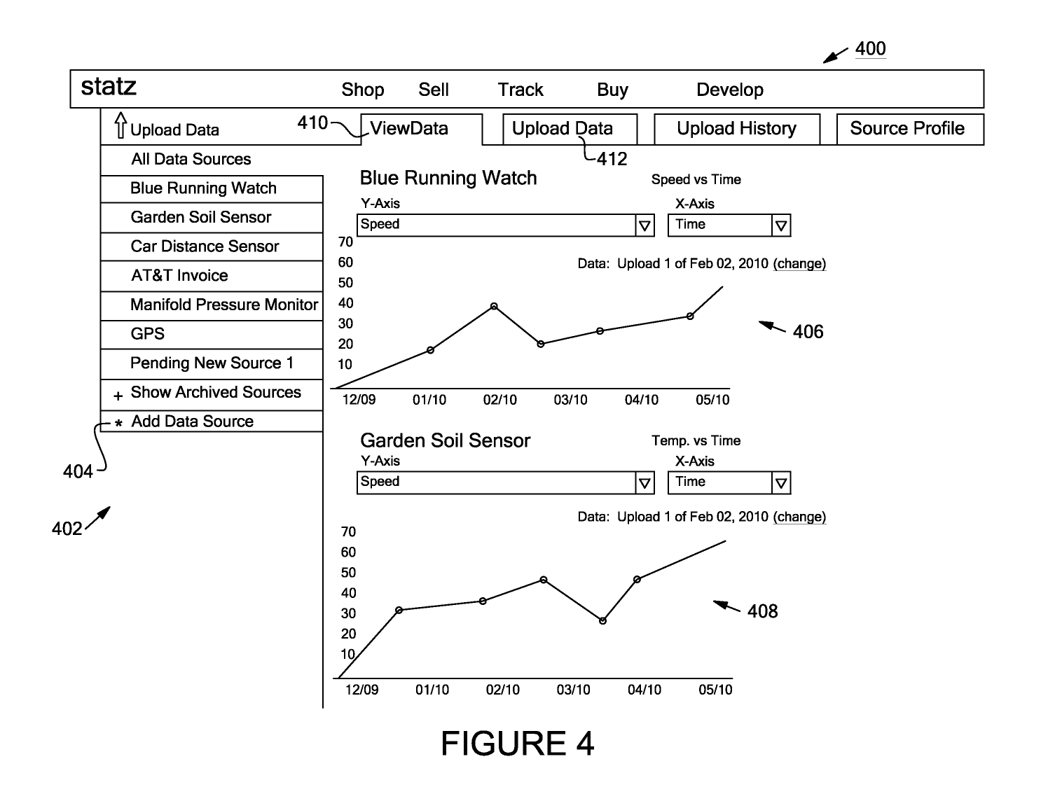

FIG. 4 shows an example of a user interface 400 used by an end user to register data sources (e.g., that provide user data for uploading) and to upload user data to online marketplace 123 according to one embodiment. User interface 400 is used by an end user of an end user device 145 to register data sources 402. For example, a new data source may be registered by clicking on an “Add Data Source” tab or icon 404.

Data sources are sources of data and may include, for example, various products or individual sensors. For example, data sources may include phones and online accounts. Also, data sources may include service provider computer systems or data streams (e.g., service provider website 158 or 170 may be a source of user data). Other data sources may include, for example, non-digital inputs like personal bills, invoices and statements, and other digital inputs from actuators, measurement devices, and cell phone and other software applications.

User data may be uploaded using an “Upload Data” tab 412. Previously uploaded data may be viewed by clicking on a “View Data” tab 410. User data associated with, for example, a “Blue Running Watch” has been uploaded to online marketplace 123 and is presented in graph 406. As another example, user data for a garden soil sensor has been previously uploaded and is presented for viewing to the user in graph 408. In one embodiment, the user interface 400 could include a user interface element, for example, a meter that depicts the value of the data uploaded from a data source, which could assist a data seller to decide on participation levels in the marketplace and their potential for earnings. Based on the presented value, the user may decide, inter alia, to include more data, withdraw the data or data source from the marketplace, or ask for a higher price.

One of the data sources 402 that has been registered by an end user is a source corresponding to a third-party service (indicated as “AT&T Invoice”). This third-party service corresponds to a service provided by service provider website 158 or service provider website 170 in some embodiments. Other examples of collecting data relating to usage by each end user of a third-party service include the usage of one of the following third-party services: website access, utility service, credit card account, bank account, and cell phone operation.

In other embodiments, the user interface 400 could include additional interface elements (not shown) that display a privacy risk, such as discussed in detail below, that comprises an estimate of the total privacy risk to the end user that sale of a data seller's data entails. Based on such a privacy risk, the data seller may choose to withdraw the data from sale. In one embodiment, the data seller, based on the total privacy risk, could add or delete elements from the data seller's data, influencing the value of the total privacy risk of the data (e.g. deleting a street address from the data, leaving only zip code, could decrease the total privacy risk). In one embodiment, the data seller could seek a higher price for disclosed data by disclosing additional data (e.g. disclosing personal income. In one embodiment, the data seller could request or demand a higher price based on the total privacy risk.

In other embodiments, the user interface 400 could include additional interface elements (not shown) that allow the user to view the privacy risk posed by disclosure of data at various levels of resolution. As in the example above, the privacy risk posed by data could be displayed at higher levels of resolution, such as a precise heart rate, or could at lower levels of resolution, be displayed for a set of ranges, for example, 60-80, 81-100, 101-120 and 121-140 BPM, or 60-80 and 81-140 BPM. The end user may ask a higher price for data at higher levels of resolution, or may prevent the sale of data at higher levels of resolution, but permit it at lower levels of resolution.

In some embodiments, user data may come from embedded sensors in cars or wireless products. Also, some user data may come from data seller invoices, such as cell phone invoices and utility invoices. The marketplace 123 will accept a data buyer's request for data based on parameters that are selected by the data buyer.

Available data sets and profiles are searched and a data set is presented for purchase. Algorithms may be used to value the data based on demand and based on value (e.g., how much privacy is associated with a selected data set). The data set is then delivered for revenue, and that revenue may be shared by the marketplace taking fees for handling or brokering the transaction, and another share of revenue going to end users that provided the data.

In one embodiment, an end user car owner has the ability to provide data from the car as a tradable data asset. The marketplace 123 can collect such data, allow searches on personal data of car owners, and permit the purchasing of data reports built in real-time from different building block data sets from different people based on search criteria specified by a data buyer, for example, data records within a date range.

In another embodiment, a sensor is placed in a bicycle to link specific consumer behavior to a specific product (i.e., the bicycle). The odometer of the bicycle uses wireless sensors. The marketplace 123 may be used, for example, to link the type of bicycle, the model of bicycle, the tire models, with the distance ridden and how the bicycle is being ridden. Data may be collected as user data and thus provide data related to the type of fatigue and use index currently used by the auto industry so that it is available for bike manufacturers. Such data could also be made available to bicycle repair shops and bicycle designers.

In one embodiment, a data buyer would go through a data taxonomy of available information selecting bicycle performance and human performance data categories. The data buyer could further select a data report to be based on age, date, etc. There may be a certain number of end users that match to those characteristics.

Marketplace 123 would then provide for a specified payment for that data report, and deliver the data in a series of different formats as may have been selected by a data buyer. In one embodiment, a share of the revenue from the data buyer can be distributed to each of the data sellers that contributed data to that sample and the remaining share of the revenue could be retained by the marketplace provider and/or shared with one or more third-party partners of the marketplace provider.

In one embodiment, marketplace 123 may identify value patterns where certain types of data are in higher demand. These trends may be identified within the demand profile created by the trading. For example, for the data taxonomy of a bicycle with heart rate, heart rate may be a high-demand data set, but the notion of how fast a user is pedaling may not have as high of a demand. In one embodiment, these trends and value patterns can be included in elements of user interfaces provided by the marketplace 123 to data sellers to help the data sellers configure data sources to increase earnings potential.

In another embodiment, marketplace 123 may create personal profiles as tradable assets for individuals on the Internet. Marketplace 123 may create a data taxonomy around behavior, provide granularity in terms of specific data of product and usage, assign a value to each of the data points, and allow those data points individually and in aggregate to be traded for value. In one embodiment, these values can be used in the calculation and presentation in a user interface to help the user decide how and how much to trade for value. In one embodiment, marketplace 123 may provide a compensation system that provides a full circuit of establishing an asset, providing a tradable platform, allowing buyers to select discretely certain aspects of those data sets, packaging those data sets into a security that is traded, and then compensating each of the constituent individual end users at a price or compensation rate that each end user has previously defined based on the end user's desired level of privacy.

### Privacy Risk Metric

In one embodiment, the marketplace 123 determines one or more privacy risk metrics that can be used, inter alia, both in aiding users to determine if they wish to disclose information, and in valuing such information. In at least one embodiment, the total level of risk to privacy, privacy and anonymity are strongly related. For example, consider a streaker. When the streaker jumps over a ball field railing, tears off his/her clothes and commences to running the bases, the streaker has given up all hope of privacy but still has his/her anonymity. Once the police catch and charge the streaker, anonymity is lost and the streaker's reputation may be damaged. Likewise, if the police ask for ID from someone who has done nothing wrong and they don't charge him with anything, his anonymity is gone, but his privacy and reputation are retained.

Thus, in one embodiment, the marketplace 123 can determine a total privacy risk metric that factors in both the potential sensitivity of a person's information and the likelihood such information could allow the identification of the person. In one embodiment, total risk to a person's privacy in disclosing information could be modeled using an equation similar or identical in form to:

R_{P}=P_{R}+(I_{R}*P_{R})
where
   R_{P} is a total risk to privacy metric associated with a person's information,
   P_{R} is a persona privacy risk metric associated with such information, and
   I_{R} is a risk of identifying a specific person from such personal information.
      This total privacy risk factor, R_{P}, reflects the general idea that the total risk to privacy is a function of both the sensitivity of information and how likely it is the person can be identified using the information, but also factors in that even if the risk of identification of the person is very low, the risk to privacy is never zero where information is potentially sensitive. The above privacy risk metric is purely exemplary, and other embodiments are possible.

### Persona Privacy Risk

In one embodiment, persona can be defined as a group of attributes that define a person's personal attributes but do not, per se, identify a specific individual. Such attributes could include a person's activities, interests, and physical attributes. Persona is thus distinguishable from identity. In one embodiment, persona can be thought of the form of a person without the final shell. It describes the person without naming them. For example, persona attributes could include:
Things owned
Places gone
Finances
Politics
100 yard sprint time
Education
Amount of time spent on eBay
Personality
Blood pressure

The potential sensitivity of such information can vary considerably. The public assignment of a given persona attributes to a specific person may or may not be objectionable. In one embodiment, persona attributes can be assigned a viewed privacy level, V_{P}, that reflects a general sensitivity weight for classes of attributes. In one embodiment, V_{P} be an integer value within a fixed range, for example, 1 to 5, where larger values of V_{P} represent increasing sensitivity. The following table provides illustrative examples of viewed privacy levels, V_{P}, for various attribute classes.

TABLE 1
Illustrative Viewed Privacy Levels

| Attribute Class | V_{P} (Sensitivity) |
|---|---|
| Competitive attributes (e.g. speed, energy | 4 |
| usage, power, distance) | |
| Consumption (e.g. energy usage, food | 2 |
| intake, spending habits, collections) | |
| Employment history | 2 |
| Finances (account balances, insurance | 4 |
| plans, mortgage bills, salary, net worth) | |
| Fitness (HR, age, weight, blood pressure) | 3 |
| Health (conditions hospitalization history, | 4 |
| prognosis, life expectancy, prescriptions) | |
| Legal History and Actions (past suits, | 5 |
| evidence of illegal activities, statutory/ | |
| mandated data, statutorily sensitive areas) | |
| Political views | 4 |
| Products owned (car model, jewelry, | 3 |
| purchased items, house size, phone plan) | |
| (Example of non-sensitive factor) | 1 |
| Temperature, automobile mileage, hiking | |
| waypoint, favorite color, average phone call | |
| time | |

The above values for V_{P} are purely illustrative, and such values could vary from person to person. For example, a person who is nearly destitute may not care if everyone knows they own nothing and have no money (e.g. a V_{P} of 1). A person who is critically ill with cancer may actually wish to actively appraise the world of the state of their health (e.g. a V_{P} of 1). Frequent job changers, on the other hand, might not want anyone to know they've held 20 jobs in the last 5 years (e.g. a V_{P} of 4 or 5).

Values established for V_{P} for data for specific individuals could also reflect the effective anonymity of data. In one embodiment, effective anonymity is the product of anonymity and observability. For example, if a person has a birthmark that is normally hidden, but three people can identify the person by the birthmark with 100% accuracy, the birthmark has a low observability factor, and thus good effective anonymity. This relationship can be used in assigning sensitivity factors for data for individuals or groups of individuals.

Values established for V_{P} for data for specific individuals or groups of individuals could also reflect the resolution (i.e. the granularity or level of detail) of data for specific attributes. For example, while political views data at a high resolution value could be at a V_{P} of 4, simply knowing that an individual voted recently could be at a lower sensitivity rating, example a V_{P} of 2. Thus, sensitivity values for political views could range from 2 to 4 depending on the resolution presented. In one embodiment, accuracy may not be as much a factor as resolution in determining V_{P}, since perceived values may be as sensitive as actual values. For example, if the data says a person earns approximately $102.5K per year, and such data was broadly exposed to the public, the person may be concerned even if the person actually made anywhere from $50K to $500K per year. However if the data said simply that the person was “Salaried”, or “Above Poverty Line”, it might cause much less concern.

In one embodiment, the V_{P} of a given data attribute or attribute class for an individual or groups of individuals could be given for specific view resolution levels, V_{R}. In one embodiment, V_{R} can take one of a range of increasing view resolution levels, for example, a range of 1-5. In one embodiment, a lookup table could be defined where, for a given class of data attributes, V_{P} could be given for a range of resolution values V_{R}. The following table provides illustrative examples of viewed privacy levels, V_{P}, for a number of specific class of attributes for a range of V_{R}. An illustrative V_{P}/V_{R} lookup table is presented below.

TABLE 2
Illustrative V_{P}/V_{R} Lookup Table

| | Sensitivity | View Resolution Level (V_{R}) | | | | |
|---|---|---|---|---|---|---|
| Attribute | Class | 1 | 2 | 3 | 4 | 5 |
| Home | Location | Index | rent/own/ | Zip | zip + 4 | address |
| | | only | couch | | | |
| | | | surf | | | |
| | Sensitivity | 1 | 1 | 3 | 4 | 5 |
| | rating (V_{P}) | | | | | |
| Latitude/ | Location | Index | track type | Distance | | Track |
| Longitude | | only | (car, bike, | covered | | |
| | | | walk, hike, | | | |
| | | | etc.) | | | |
| | Sensitivity | 1 | 1 | 1 | 1 | 5 |
| | rating (V_{P}) | | | | | |
| Pets | Things | Index | y/n | type(s) | Pet age, | Pet health |
| | owned | only | | | weight, | |
| | | | | | type | |
| | Sensitivity | 1 | 1 | 2 | 2 | 3 |
| | rating (V_{P}) | | | | | |
| Car info | Things | Index | y/n | number | models/ | VINs |
| | owned | only | | owned | year | |
| | Sensitivity | 1 | 1 | 2 | 3 | 3 |
| | rating (V_{P}) | | | | | |
| Car | Things | Index | NA | NA | DIY? | maintenance |
| Maintenance | owned | only | | | | log |
| | Sensitivity | 1 | 1 | 1 | 1 | 3 |
| | rating (V_{P}) | | | | | |
| Car usage or | Things | Index | # | mileage per | toll log, | ODB-II log |
| ODB-II log | owned | only | drivers/ | interval | MPG Log | |
| | | | car | | | |
| | Sensitivity | 1 | 1 | 2 | 3 | 5 |
| | rating (V_{P}) | | | | | |
| Name | Name | Index | No ID | UserID | UserID | Full name |
| | | only | | | | |
| | Sensitivity | 1 | 1 | 2 | 2 | 5 |
| | rating (V_{P}) | | | | | |
| Alias | Name | Index | No ID | UserID | UserID | Alias |
| (including | | only | | | | |
| email | Sensitivity | 1 | 1 | 2 | 2 | 4 |
| address and | rating (V_{P}) | | | | | |
| userID) | | | | | | |
| Blood | Health - OTC | Index | Type | Matching | HR | BP, RB/WBC |
| | | only | | factors | | count |
| | Sensitivity | 1 | 1 | 3 | 3 | 5 |
| | rating (V_{P}) | | | | | |
| Eye | Health - OTC | Index | Correction | Glasses | | Pressure, |
| prescription | | only | needed? | prescription, | | prescriptions |
| | | | | color blind | | |
| | Sensitivity | 1 | 1 | 2 | 2 | 5 |
| | rating (V_{P}) | | | | | |
| Cycling log | Activity/ | Index | Miles per | Avg miles, | Power, | Ride logs w/ |
| | Fitness/ | only | year | avg speed | cadence, | location |
| | Location | | | for all | etc logs | |
| | | | | logged rides | | |
| | Sensitivity | 1 | 1 | 1 | 3 | 4 |
| | rating (V_{P}) | | | | | |
| Diving log | Activity | Index | Dive y/n | Lifetime | Dive | Dive logs |
| | | only | | dive count | locations | |
| | Sensitivity | 1 | 1 | 1 | 2 | 3 |
| | rating (V_{P}) | | | | | |
| Phone | Communica- | Index | Cell phone/ | Carrier | Minutes | call log |
| records | tions | only | landline | | used, avg | |
| | | | y/n | | minutes, | |
| | | | | | # calls | |
| | Sensitivity | 1 | 1 | 1 | 2 | 3 |
| | rating (V_{P}) | | | | | |
| eBay records | Financial/ | Index | Transaction | Total credit/ | Buy/sell | Transaction |
| | Things | only | count | debit | product | records |
| | owned | | (credit/ | | category | |
| | | | debit) | | count | |
| | Sensitivity | 1 | 1 | 2 | 2 | 3 |
| | rating (V_{P}) | | | | | |
| Paypal | Financial/ | Index | Transaction | Total credit/ | | Transaction |
| records | Things | only | count | debit | | records |
| | Owned | | (credit/ | | | |
| | | | debit) | | | |
| | Sensitivity | 1 | 1 | 3 | 3 | 5 |
| | rating (V_{P}) | | | | | |
| Bank account | Financial | Index | owned | Transaction | Total | Transaction |
| | | only | account | count | credit/ | records |
| | | | types | (credit/ | debit | |
| | | | | debit) | | |
| | Sensitivity | 1 | 2 | 3 | 4 | 5 |
| | rating (V_{P}) | | | | | |
| Credit card | Financial | Index | card | Transaction | Total | Transaction |
| account | | only | count/ | count | credit/ | records |
| | | | type | (credit/ | debit | |
| | | | | debit) | | |
| | Sensitivity | 1 | 2 | 3 | 4 | 5 |
| | rating (V_{P}) | | | | | |
| Outdoor | Environment/ | Index | Weather | temp/RH | precip, | solar power, |
| weather | Location | only | zone | log | wind | air |
| | | | | | | particulates |
| | Sensitivity | 1 | 1 | 1 | 3 | 3 |
| | rating (V_{P}) | | | | | |
| Indoor | Environment | Index | weather | temp/rh log | Individual | energy |
| environment | | only | zone | | appliance | usage |
| | | | | | energy | |
| | | | | | log, CO, | |
| | | | | | CO2, | |
| | | | | | particulates | |
| | Sensitivity | 1 | 1 | 1 | 2 | 3 |
| | rating (V_{P}) | | | | | |
| Netflix | Media | Index | y/n | Movie count | by | Movie List |
| | | only | | | category | |
| | | | | | count | |
| | Sensitivity | 1 | 1 | 1 | 4 | 5 |
| | rating (V_{P}) | | | | | |
| Amazon | Media | Index | y/n | book count | by | book list |
| books | | only | | | category | |
| | | | | | count | |
| | Sensitivity | 1 | 1 | 1 | 4 | 5 |
| | rating (V_{P}) | | | | | |
| Library | Media | Index | y/n | Book count | by | book list |
| records | | only | | | category | |
| | | | | | count | |
| | Sensitivity | 1 | 1 | 1 | 4 | 5 |
| | rating (V_{P}) | | | | | |
| House | Things | Index | rent/own/ | # rooms | room list, | room |
| dimensions | owned | only | couch | | sq | dimensions |
| | | | surf | | footage | |
| | | | | | total | |
| | Sensitivity | 1 | 1 | 2 | 2 | 2 |
| | rating (V_{P}) | | | | | |
| House value | Things | Index | area | Above/below | | $ amount |
| estimate | owned | only | average | average | | |
| | | | (nearest | | | |
| | | | $10K) | | | |
| | Sensitivity | 1 | 2 | 2 | 2 | 4 |
| | rating (V_{P}) | | | | | |
| Product run- | Things | Index | NA | NA | log | |
| hours, stress | owned | only | | | records | |
| log | Sensitivity | 1 | 1 | 1 | 2 | 2 |
| | rating (V_{P}) | | | | | |
| Political | Political | Index | y/n | when voted | party | Contribution |
| Contributions | | only | | | affiliation | records |
| | Sensitivity | 1 | 1 | 2 | 4 | 5 |
| | rating (V_{P}) | | | | | |
| Blog/ | Media | Index | y/n | post count | post | post |
| Twitter Posts | | only | | | statistics | content |
| | | | | | (content | |
| | | | | | analysis) | |
| | Sensitivity | 1 | 1 | 1 | 3 | 4 |
| | rating (V_{P}) | | | | | |
| Windows | Things | Index | System | Installed SW | | Full logs |
| Logs | owned | only | info | | | |
| | Sensitivity | 1 | 2 | 2 | 2 | 3 |
| | rating (V_{P}) | | | | | |
| Weight/ | Fitness | Index | On | Workout | Diet log | Weight log |
| dietary log | | only | Managed | activity | | |
| | | | Diet (y/n) | | | |
| | Sensitivity | 1 | 1 | 2 | 2 | 3 |
| | rating (V_{P}) | | | | | |
| Images - Exif | Things | Index | Photo | Photo count | Aperture, | Full EXIF |
| | owned | only | count, | per camera, | Shutter, | |
| | | | number | digital | basic info | |
| | | | cameras | retouching | | |
| | | | | program, | | |
| | | | | camera | | |
| | | | | model | | |
| | Sensitivity | 1 | 1 | 1 | 1 | 3 |
| | rating (V_{P}) | | | | | |
| Shipment | Financial | Index | Shippers, | Total weight | Destinations | Full records |
| logs | | only | Total | shipped | | |
| | | | count of | | | |
| | | | records | | | |
| | Sensitivity | 1 | 2 | 2 | 3 | 4 |
| | rating (V_{P}) | | | | | |

The above values for V_{P} at various V_{R} levels are purely illustrative, and such values could vary from person to person. Furthermore, in alternative embodiments, values for effective anonymity and/or data resolution levels, V_{R}, values could be used to modify the effective value of V_{P} using other forms of algorithmic transformation or data lookups. For example, the value of V_{P} at a given V_{R}, V_{PR}, could be determined as follows:

V_{P(R)}=V_{P(max)}*V_{R}/V_{R(max)}

(V_{P(R)} is the product of the V_{P} maximum value for that category, multiplied by the fraction of the maximum V_{R} value that is the currently selected V_{R} value.) Such a transformation is purely exemplary, and any other form of algorithmic transformation or transformation via a data lookup could be used, as will be readily apparent to those skilled in the art.

In various embodiments, the V_{P} for a given class of attributes at a given level of resolution V_{R}, however, may not accurately reflect the true magnitude of the effective sensitivity of such information. For example, data classed at a V_{P} of 5 may be qualitatively far more than 2.5 times as sensitive as data classed at a V_{P} of 2. For example, in the case of table 2, a person's state, city and street of residence or details of their health record is far more sensitive than their city of residence or their blood type respectively. In one embodiment, such qualitative differences may be quantified to calculate an effective data sensitivity value, S_{D}, by using V_{P} to define a exponential scale. For example:

S_{D}=e^{vp}
where
   S_{D} an effective data sensitivity for a single attribute,
   e is mathematical constant called Euler's number, and
   V_{P} is a viewed privacy level as described above.
      In such a case, S_{D} ranges from a low of 2.718 to a high of 148.4. Such an embodiment is purely exemplary, and other ways of using V_{P} to define an exponential scale, logarithmic, multiplicative or fractional scale can be used in other embodiments. In other embodiments, either or both V_{P} and S_{D} may be assigned values as a result of an end-user survey. In one embodiment, the assigned values may be direct outcomes of the survey. In other embodiments, the values may be derived from the survey results.

In one embodiment, once the effective sensitivity for a person's persona data has been determined, a persona privacy risk metric, P_{R}, associated with the person's data can be determined. In one embodiment, if data revealed about a person comprises a single attribute, then, in one embodiment, P_{R}=S_{D}. In various other embodiments, persona related data relating to a particular individual can comprise multiple attributes. As the total number of revealed attributes relating to an individual increase, the combined privacy risk of the data as a whole can potentially increase as well. On the other hand, once a person's most sensitive information is exposed, the less effect, if any, the disclosure of additional information has on the combined sensitivity of the persona data containing multiple attributes. For example, if a person's bank account numbers and balances have been revealed, it is of little consequence to the person if the person's blood type or favorite flavor of ice cream are revealed.

In one embodiment, a persona privacy risk metric, P_{R}, can be determined for a group of persona attributes where P_{R} increases with the number of attributes revealed, but where more sensitive attributes are more heavily weighted in the calculation. In one embodiment, a set of data sensitivity values, {S_{D(1)} . . . S_{D(n)})} for a group of persona attributes is used to calculate the total P_{R} for that individual over all attributes. P_{R} increases as average sensitivity of all attributes increases and increases as more sensitive attributes are revealed. For example:

P_{R}=ê(max(S_{D})+avg(S_{D}))
where
   P_{R} persona privacy risk for a group of n attributes,
   e is a mathematical constant called Euler's number,
   S_{D} are the respective sensitivities for individual attributes,
   max(S_{D}) is the maximum data sensitivity among all n attributes, and
   avg(S_{D}) is the average data sensitivity among all n attributes.
   ê is common mathematical shorthand for “e to the power of”
      The above equation is purely illustrative, and other embodiments having similar behavior are possible. For example, e is used as the base of the exponent to provide a useful arbitrary scale. The exponent base could also 10, or the exponent and other normalizing functions could be selected to fit the possible result values into a useful range for display and reporting (such as 1 to 5, or 1 to 10). Where the persona attribute has a null value of S_{D} for a particular category, i.e. that attribute does not have any associated data, a value of 0 can be used in calculating the average S_{D}.

### Identity Privacy Risk

In one embodiment, as noted above, identity privacy risk I_{R} is the risk that a specific person can be identified from personal information. For example, the following attributes can be used to identify a specific person or the slightly more anonymous—“an individual”:
Legal name—This is a person's name (whether a given name or one legally assumed later) that they use with other persons and entities in the real world. Names are not usually unique (except possibly in the case of very unusual, non-traditional names) but rather, are usually quite common and used by hundreds or thousands of individuals.
Nicknames and aliases such as email or online userIDs—Aliases may be used to model an identity, but by themselves, may or may not identify, a specific person. The ability to use an online alias to identify a specific person is dependent on the relationship of the Alias to the Legal Name and the number of publicly distributed contexts in which both the legal name and alias are included. For example, if a person places their legal name and alias on a large number of public websites, then the alias is essentially equivalent to a legal name.
Account numbers and Social Security Numbers—Can be regarded in many respects as aliases, as while such numbers relate very precisely to a specific individual or entity, determining the identity of such person from such data requires additional information.
Location—A recurring location in a data log often indicates a home, workplace, friend's house or similar relationship. A location by itself has a high correlation with identity, and but also may include a potential behavior component (e.g. locations frequently visited may reveal something about persona).
Unique products owned—Unique products owned can be regarded in many respects as equivalent to an alias to those who are able to observe them, and identify that they are unique. E.g. “Hey! Aston-Martin guy!”, “The Manolo Blahnik chick”. In one embodiment, the identification value of a product includes both the uniqueness and observability of the product.
Unique behavior or characteristic—Unique behavior characteristics can be regarded in many respects as equivalent to an alias, if they are known or observable. For example, there may be only one individual with a body weight of 1200 lbs, and cyclists who can ride a 25 mile time trial averaging 30 MPH are very few in number. On the other hand, people with a normal heart rate of 40 or an IQ of 190 are relatively rare, but such characteristics have very limited visibility to a casual observer.
Unique environment—Environmental measurements like sun rise/set times, precipitation, temperature, and wind speed and direction can be used to identify a location. A rich enough log of environmental measurements can be used to identify a unique location.

Note that data relating to identity can also include potentially sensitive persona information. Thus, a legal name may suggest an ethnic or religious affiliation, or an email address may also disclose membership in a controversial organization. Location information, at a fine enough level of detail, may reveal a person's possible participation in controversial, unsavory or even criminal activities.

Various types of information that tend to suggest identity can be combined, cross-referenced and analyzed to identify a person precisely, or at least to identify a small group of possibilities. Generally speaking, the more information available about a person, the more likely it is a person can be identified, even if each individual atom of information about a person is relatively general—it is the combination that is revealing. Thus, in revealing a given set of information, an identity privacy risk I_{R} can be quantified. In one embodiment, when an individual discloses a set of information, an identity privacy risk I_{R} can be determined using a combination of privacy risk estimates for individual attributes within such a set of information.

Such an identity privacy risk metric need not use a privacy risk estimate for every data element disclosed for a person. For example, one method of calculating an I_{R} can use name, alias and location. In one embodiment, assume a name could have a V_{P} range of 1 to 4, depending on the specific name attribute and the view resolution of the attribute, while an alias will have a V_{P} range of 1 to 3, depending on the specific name attribute and the view resolution of the attribute. The maximum value logged in either the name or alias category will be carried forward. Location, which could at high resolution link to an identity more precisely than most names, could have a range for V_{P} that covers the full scale of 1 to 5, again depending on the view resolution of the location attribute.

In one embodiment, the value of I_{R} can thus vary, depending on the view resolution of the name, alias and location attributes used in the determination. In one embodiment, the following equation could be used:

I_{R}=(max(V_{P(name/alias)}*max(V_{P(location)})−1)/scaling factor
where I_{R} is the identity privacy risk for a group of n attributes,
   max(V_{P(Name/Alias)}) is the maximum V_{P} for all disclosed name and alias attributes at a given view resolution.
   max(V_{P(location)}) is the maximum V_{P} for all disclosed location attributes at a given view resolution.
   scaling factor is a scaling factor selected such that the value of I_{R} is in the range of 0 to 1.

In one embodiment, scaling factor can represent the product of the maximum possible privacy level for all name attributes and the maximum possible privacy level for all location attributes. Typically, maximum possible privacy level for a name, alias or location attribute will be the privacy level of such an attribute at the maximum available view resolution.

In the example provided above, the scaling factor is 19 (a maximum possible V_{P} of 4 for name/alias*a maximum possible V_{P} of 5 for location−1). In the illustrated embodiment, I_{R} ranges between 0 and 1, Where the total privacy risk estimate, R_{P}, is calculated as R_{P}=P_{R}+(I_{R}*P_{R}), R_{P} ranges between P_{R} and P_{R}*2. The above equation for calculating I_{R} is purely illustrative, and other methods utilizing more, less or different attributes combined using any mathematical or statistical techniques known in the art could be utilized, as will be readily apparent to those skilled in the art.

### An Illustrative Embodiment of Use of Privacy Risk Metric in an Online Data Marketplace

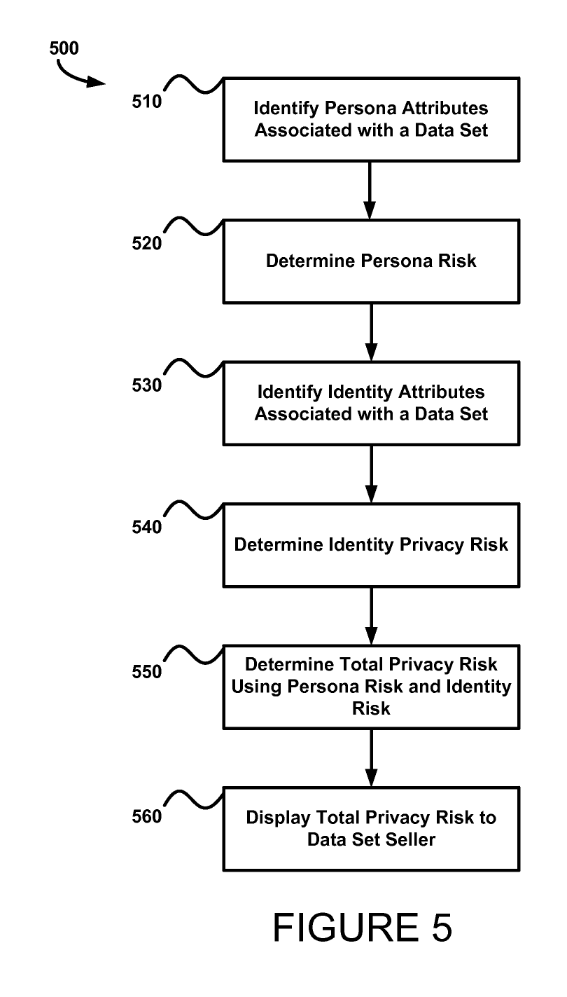

FIG. 5 shows an embodiment of a process where a privacy risk metric could be determined and used within an online data marketplace. In the examples below, where reference is made to “a system” or “the system” or “a computing device”, it should be understood as referring to, in various embodiments, components of an online data marketplace that supports privacy risk metrics. Such components can comprise, in various embodiments, combinations of processors and storage devices capable of executing program logic for the various functions below. In at least one embodiment, the system is composed entirely of elements hosted on, or supported by, one or more servers. In other embodiments, certain functions could be performed, at least in part, by client-side processing on client devices owned and/or controlled by data buyers and sellers.

In block 510, at least one persona data attribute is identified, using a computing device, associated with a data set received from a data seller. In one embodiment, as described above, persona data attributes represent any data that define a person's personal attributes but may not, per se, identify a specific individual. Such attributes could include, inter alia, a person's activities, interests, and physical attributes.

In one embodiment, one or more persona attribute lookup tables, for example data dictionaries, could be maintained that identify specific data attributes as data attributes relating to a seller's persona. In one embodiment, such lookup tables could be system-wide lookup tables. In one embodiment, such lookup tables could be seller-specific lookup tables stored, for example, as part of a user profile associated with a specific identified data seller. In one embodiment, such lookup tables could be data set-specific lookup tables stored in user data profiles.

Persona attributes may be associated with the data set via any means by which data values can be embedded in, or linked to the data set, directly or indirectly. In one embodiment, such attributes may represent data that is actually in the data set. In one embodiment, such attributes may represent data that is in a profile linked to the dataset. In one embodiment, such attributes may represent data that is in other data sets or available via external sources of information, such as websites, where the attributes can be related to the data set via data in the data set or in a profile associated with the dataset.

In one embodiment, the system can provide various means for a seller to add, delete and update user and user data profiles. For example, the system could provide a browser based interface, over the network, for sellers to define and maintain user profiles and user data profiles. Alternatively, or additionally, user profiles could be defined on a user's computing device and uploaded to the system. Alternatively, or additionally, user data profiles for a data set could be defined on a user's computing device and uploaded to the system with the data set.

In block 520, a persona privacy risk metric, P_{R}, is determined, using a computing device, for persona data attributes in the data set. In one embodiment, the persona privacy risk, P_{R}, comprises an estimate of the potential sensitivity of persona data associated with persona data attributes in the data set. In one embodiment, the persona privacy risk metric, P_{R}, is determined by combining the effective data sensitivities, S_{D}, of one or more persona attributes in the data set.

In one embodiment, the persona privacy risk metric, P_{R}, can be determined for a group of persona attributes where P_{R} increases with the number of attributes revealed, but where more sensitive attributes are more heavily weighted in the calculation. In one embodiment, a data sensitivity, S_{D}, can be determined for a group of persona attributes where P_{R} increases with as average sensitivity of all attributes increases and increases as more sensitive attributes are revealed, for example, P_{R}=ê(max(S_{D})+avg(S_{D})), as described in greater detail above.

In one embodiment, as described above, effective data sensitivities, S_{D}, can, in turn be determined using viewed privacy levels, V_{P}, that reflect a general sensitivity weight for persona data attributes or classes of attributes. In one embodiment, V_{P} can be assigned an integer value within a fixed range, for example, 1 to 5, where the larger values of V_{P} represent increasing sensitivity. In one embodiment, the V_{P} of a given data attribute could be determined for specific view resolution levels, V_{R}. In one embodiment, V_{R} can take one of a range of increasing view resolution levels, for example, a range of 1-5.

In one embodiment, values for V_{P}, and/or values for V_{P} at a range of resolutions could be stored on one or more persona attribute lookup tables. As noted above, such persona attribute lookup tables could be system-wide lookup tables, seller-specific lookup tables stored, for example, as part of a user profile associated with a specific identified data seller, and/or data set-specific lookup tables stored in user data profiles. In one embodiment, values for V_{P}, and/or values for V_{P} at a range of resolutions V_{R} could be stored on one or more persona attribute lookup tables. In one embodiment, values for V_{P} at a range of resolutions V_{R} could be calculated algorithmically, as described in greater detail above.

In one embodiment, such persona attribute lookup tables could specify that certain specific data elements or specific data elements at a given resolution V_{R} are not to be provided to data buyers. In one embodiment, such persona attribute lookup tables could provide definitions for specific view resolution levels V_{R}. For example, such definitions could specify that at a given V_{R} for a particular data element, components of the data should be selected or masked. For example, the last 4 digits of a 7 digit Zip Code could be masked, or a City and State could be selected from a full address. In one embodiment, data that is especially sensitive could be encrypted on copies of the data set stored on the system using, for example, a two way encryption scheme.

In one embodiment, the effective data sensitivities, S_{D}, for persona data attributes can be determined by using the V_{P} for such persona data attributes as an exponent in an exponential scale, for example, S_{D}=e^{vp}, as described in greater detail above.

In block 530, at least one identity data attribute is identified, using a computing device, associated with a data set received from a data seller. In one embodiment, as described above, identity data attributes represent any data that identify, or tend to identify, a specific individual or small group of individuals, such as legal names, nicknames and aliases, account numbers and Social Security Numbers, location information, unique products owned, unique behavior, unique personal characteristics and unique environments.

In one embodiment, one or more identity attribute lookup tables, for example data dictionaries, could be maintained that identify specific data attributes as data attributes relating to a data seller's identity. In one embodiment, such lookup tables could be system-wide lookup tables. In one embodiment, such lookup tables could be seller-specific lookup tables stored, for example, as part of a user profile associated with a specific identified data seller. In one embodiment, such lookup tables could data set-specific lookup tables stored in user data profiles.

Identity attributes may be associated with the data set via any means by which data values can be embedded in, or linked to the data set, directly or indirectly. In one embodiment, such attributes may represent data that is actually in the data set. In one embodiment, such attributes may represent data that is in a profile linked to the dataset. In one embodiment, such attributes may represent data that is in other data sets or available via external sources of information, such as websites, where the attributes can be related to the data set via data in the data set or in a profile associated with the dataset.

In one embodiment, the system can provide various means for a seller to add, delete and update such user and user data profiles. For example, the system could provide a browser based interface, over the network, for sellers to define and maintain user profiles and user data profiles. Alternatively, or additionally, user profiles could be defined on a user's computing device and uploaded to the system. Alternatively, or additionally, user data profiles for a data set could be defined on a user's computing device and uploaded to the system with the data set.

In one embodiment, identity attribute lookup tables could provide that components of the data should be selected or masked. For example, the first 5 digits of a Social Security Number could be masked, or a City and State could be selected from a full address.

In block 540, an identity privacy risk, I_{R}, is determined using a computing device, for identity data attributes in the data set. In one embodiment, the identity privacy risk, I_{R}, comprises a combination of privacy risk estimates for individual identity attributes within the data set.

In one embodiment, as described above, privacy risk estimates for identity data attributes comprise viewed privacy levels, V_{P}, for such attributes. As in the case of persona data attributes, V_{P} can be assigned to be an integer value within a fixed range, for example, 1 to 5, where the higher values of V_{P} represents increasing sensitivity. In one embodiment, values for V_{P} for identity attribute could be stored on one or more attribute lookup tables. As noted above, such identity attribute lookup tables could be system-wide lookup tables, seller-specific lookup tables stored, for example, as part of a user profile associated with a specific identified data seller, and/or data set-specific lookup tables stored in user data profiles.

In one embodiment, the identity privacy risk value, I_{R}, is determined using a limited number of identity attributes. For example, one method of calculating an I_{R} can use name, alias and location, for example, I_{R}=max(V_{P(name/alias)})*max(V_{P(location)})/max(name*location), as described in greater detail above.

In one embodiment, one or more attributes within a data set comprise both persona and identity attributes. In one embodiment, persona and identity lookup tables comprise a single table or set of tables,

In block 550, a total privacy risk metric, R_{P}, can then be determined for a data set using a computing device using persona privacy risk metric, P_{R}, and the identity privacy risk, I_{R}. In one embodiment, total privacy risk metric, R_{P}, comprises an estimate of the total risk to a person that the disclosure of information represents. In one embodiment, the total privacy risk metric, R_{P}, factors in both the potential sensitivity of a person's information and the likelihood such information could allow the identification of the person. In one embodiment, the total risk to privacy, R_{P}, for a data set is directly proportional to both the sensitivity of persona information in the data set and how likely it is a person can be identified using identity information in the data set, for example, R_{P}=P_{R}+(I_{R}*P_{R})), as described in greater detail above.

In block 560, the privacy risk metric, R_{P}, associated with a data set can then be displayed to the data seller. In one embodiment, if the R_{P} is unacceptably high, the data seller may choose to withdraw the data from the marketplace. In one embodiment, if the R_{P} is unacceptably high, the data seller may, alternatively, adjust view resolutions, V_{R}, for a set of one or more persona data attributes within the data set to lower the R_{P} associated with the data set.

In one embodiment, a data set may be associated with a plurality of R_{P} values, where each value of R_{P} is associated with a set of different view resolutions, V_{R}, for a set of one or more persona data attributes within the data set. In one embodiment, a data seller may choose to offer a data set for sale within a data marketplace at a plurality of view resolutions, V_{R}, where compensation for the data increases as the data set's R_{P} increases.

It should be understood that while the determination and use of privacy risk factors for user's data is discussed above with reference to a data marketplace, such techniques could also be used in any third party websites, applications and/or services where a user's data is exposed to third parties. For example, the same general method of separating identity from persona and then determining a single value from the persona and identity components can be used to rate and tune privacy settings on FACEBOOK or LINKEDIN websites. A further adaptation could be made for desktop and mobile applications with privacy related settings (e.g. browsers, network configuration, accounting applications).

### Valuation Estimate Framework and User Interface

In one embodiment, the marketplace 123 can estimate the value of a data seller's data. In one embodiment, a valuation estimate is a metric that expresses a relative magnitude of the earnings a data seller can anticipate from sale of the seller's data. The estimate could be presented in any of a number of formats. For example, the valuation estimate could be expressed in the total expected income from sale of the data, an expected monthly or yearly income from sale of the data, or a net present value of the anticipated income from sale of the data. Alternatively, valuation estimates could be expressed using a relative scale, for example 1 to 10, 1 representing data having little or no value in the marketplace 123 and 10 representing data having the greatest actual or potential value in the marketplace.

In one embodiment, such valuation estimates could be presented to data sellers through one or more user interface elements provided by the marketplace. One such embodiment could a bar graph that displays the data seller's earnings estimate over time. Another such embodiment could include a valuation estimate of the user's data expressed as a numeric score, which could be presented as a text number or a graphical meter. Such valuation estimates, in combination with privacy risk metrics can enable prospective data sellers to make an informed decision as to whether they wish to sell their data through the marketplace.

In one embodiment, a valuation estimate could be calculated using an equation of the general form:

V=ƒ[(x₀,v₀),(x₁,v₁),(x₂,v₂) . . . (xₙ,vₙ)]
where
   V is a valuation estimate,
   n+1 elements (e.g. fields) within the data are used in the estimate
   ƒ is a valuation function
   xₙ is a weighting factor for each contributing element n and
   vₙ is a value for each contributing element n.

In various embodiments, the valuation function ƒ could represent any type of function where the weighed value of each component element is combined using any forecasting or estimation technique known in the art to provide a valuation estimate, whether expressed as a relative value or estimated income. In one embodiment, the valuation function ƒ could take the form of a linear equation, where the value for each element is multiplied by its respective weight, and the products of such operations are added together, for example:

V=(x₀*v₀)+(x₁*v₁)+(x₂*v₂) . . . (xₙ*vₙ)

In other embodiments, ƒ could alternatively be a non-linear equation. In other embodiments, ƒ could alternatively represent a trained classifier, for example a support vector machine (SVM).

In various embodiments, the valuation could rise or fall based on, but not limited to, elements relating to a variety of categories. For example, in one embodiment, the valuation estimate could rise or fall based on, but not limited to, the following list of data seller elements.
Age of seller's data marketplace account.
Completeness of data in data seller's data in the data marketplace.
Frequency of and consistency of data seller's data in the data marketplace.
Number of sources in data seller's data in the data marketplace.
Variety and diversity of data sources in data seller's data in the data marketplace.
Frequency of inclusion of data seller's data in data marketplace reports.
Participation of data seller in social networks (quality and number of connections).
Comparison of data seller's data with public/standardized population data relative to mean and standard deviation of public/standardized population.
Correlation of data seller's data with external events.

In one embodiment, the valuation estimate could rise or fall based on, but not limited to, the following list of data buyer (customer) elements.
Information in buyers' data marketplace accounts.
Market segment of data purchased by buyers.
Purchasing pricing schedule for buyers' purchase of data from the marketplace.
Buyers' purchase history.

In one embodiment, the valuation estimate could rise or fall based on, but not limited to, the following list of data marketplace contributing elements.
Total sales of data within the data marketplace in a market segment.
Velocity of sales within the data marketplace in a market segment.
Total number of data records within the data marketplace contained in a market segment.
Total amount of data within the data marketplace in a market segment.
Frequency of market segment selection by buyers.

In one embodiment, the valuation estimate could rise or fall based on, but not limited to, the following list of external market segment contributing elements.
External market segment size.
Value of external market segment.
Relation to indexes and other research reports for external market segment.
News/announcements connected with the market segment.
Seasonality of market segment.

In one embodiment, the valuation estimate could rise or fall based on, but not limited to, the following list of social-networking contributing elements:
Number of new users of the marketplace a current user brings in by referral and/or invitation.
Number of additional new users of the marketplace registered in turn by such new users.
The amount of data uploaded by such new users and those they invite.

In one embodiment, the valuation estimate could rise or fall based on, but not limited to, the following list of privacy risk contributing elements.
Persona privacy risk for data sellers.
Identity privacy risk for data sellers.
Total privacy risk for data sellers.

In one embodiment, values, vₙ, for individual data elements, could be expressed as numeric values. Such values could represent actual, unnormalized values for the element in question. For example, the total sales for a data in a market segment could be expressed in units (e.g. number of discreet sales), records (e.g. total number of data records sold) or in revenue (e.g. dollars of revenue). Alternatively, such numbers could be normalized. In one embodiment, such numbers could be normalized by dividing or multiplying the numbers using a simple factor, such as, for example, 1,000. In one embodiment, such numbers could be normalized by determining a logarithm of any base for such numbers or such numbers could be raised to some whole or fractional exponential power.

Where the value of data elements, in their native form, are not numeric, numeric values for such elements could be determined using any technique known in the art for transforming non-numeric values to numeric values. For example, a market segment for data may be literally defined by the categories of information present in the market segment, or by the characteristics of buyers of data in the market segment. The market segment may, however, be assigned a numeric value reflecting the relative value of information in the market segment using, for example, a lookup table.

In one embodiment, values, xₙ, for individual weights, could be expressed as numeric values. In one embodiment, weights could be manually assigned to specific data elements based on a expert's estimate of the weight of the data element in estimating a dataset's value. In one embodiment, weights could be manually assigned to specific data elements based on a prospective data buyer's estimate of the weight of the data element in estimating a dataset's value. In one embodiment, weights could be assigned to specific data elements based on a statistical analysis of historical prices data buyers have paid for data sets including such elements.

### An Illustrative Embodiment of Use of a Valuation Estimate in an Online Data Marketplace

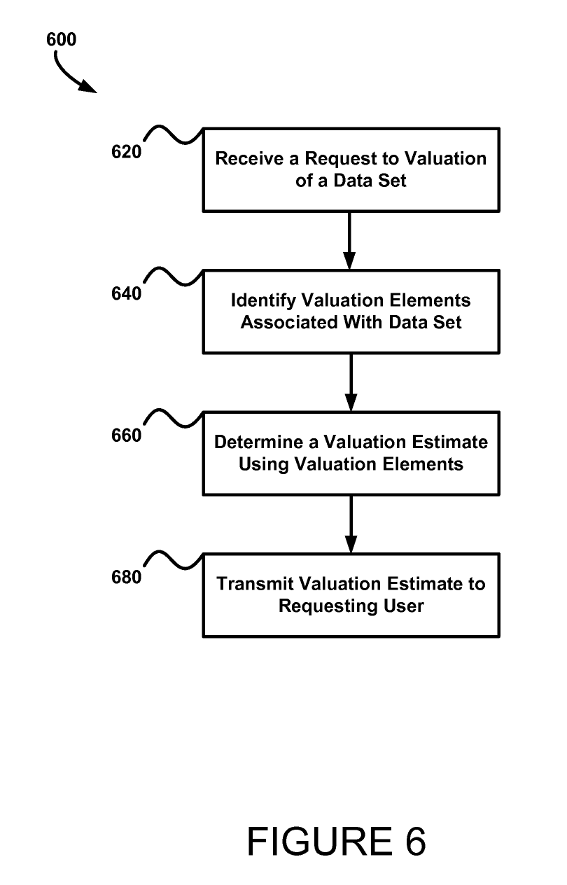

FIG. 6 shows an embodiment of a process where valuation estimate could be determined and used within an online data marketplace. In the examples below, where reference is made to “a system” or “the system” or “a computing device”, it should be understood as referring to, in various embodiments, components of an online data marketplace that supports data valuation. Such components can comprise, in various embodiments, combinations of processors and storage devices capable of executing program logic for the various functions below. In at least one embodiment, the system is composed entirely of elements hosted on, or supported by, one or more servers. In other embodiments, certain functions could be performed, at least in part, by client-side processing on client devices owned and/or controlled by data buyers and sellers.

In block 620, a request for a valuation of a data set received from a data seller is received over a network, from a requesting user. In one embodiment, the data set is stored in a data marketplace such as that described in detail above. In one embodiment, the request is submitted by a seller of the data set using a user interface provided by the data marketplace over the network, such as, for example, a browser based user interface provided over the Internet. In one embodiment, the request is submitted by a prospective buyer of the data set using a user interface provided by the data marketplace over the network, such as, for example, a browser based user interface provided over the Internet. In one embodiment, the data set is a data set that was previously uploaded to the data marketplace by a data seller. In one embodiment, the data set is a data set located on a computing system controlled by the data seller which is known to the data marketplace.

In block 640, a plurality of valuation elements associated with the data set is identified using a data processing system. A valuation element should be understood to represent a data field or set of data fields or attributes that relate to the data set that can be used to estimate the value of data in the data set in the marketplace.

In one embodiment, one or more data valuation element lookup tables, for example data dictionaries, could be maintained that identify specific data attributes as elements relating to data valuation. In one embodiment, such lookup tables could be system-wide lookup tables. In one embodiment, such lookup tables could be seller-specific lookup tables stored, for example, as part of a user profile associated with a specific identified data seller. In one embodiment, such lookup tables could be data set-specific lookup tables stored in user data profiles.

Valuation elements may be associated with the data set via any means by which data values can be embedded in, or linked to the data set, directly or indirectly. In one embodiment, such elements may represent data that is actually in the data set. In one embodiment, such elements may represent data that is in a profile linked to the dataset. In one embodiment, such elements may represent data that is in other data sets or available via external sources of information, such as websites, where the elements can be related to the data set via data in the data set or in a profile associated with the dataset.

In block 660, a data valuation estimate, V, is determined, using the data processing system, for the data set using the plurality of valuation elements. In one embodiment, the plurality of valuation elements comprise a set of n+1 elements, numbered 0 to n, and the valuation estimate, V, is determined using the equation V=ƒ[(x₀,v₀),(x₁,v₁),(x₂,v₂) . . . (xₙ,vₙ)], as described in detail above. In one embodiment, the valuation function ƒ is a linear equation a form such that: V=(x₀*v₀)+(x₁*v₁)+(x₂*v₂) . . . (xₙ*vₙ). In one embodiment, the valuation function ƒ is a non-linear equation. In one embodiment, the valuation function ƒ is a trained classifier.

In various embodiments, at least some of the plurality of valuation elements associated with the data set are data seller data elements, data buyer data elements, data marketplace data elements, external market segment data elements, social-networking data elements, and/or privacy risk data elements such as, without limitation, those described in detail above.

In block 680, a representation of the data valuation estimate, V, is transmitted, over the network, to the requesting user such that the representation of the data valuation estimate is caused to be displayed on a display device associated with the requesting user. In one embodiment, the representation of the data valuation is presented to a buyer or seller of the dataset using a user interface provided by a data marketplace over a network, such as, for example, a browser based user interface provided over the Internet.

The data valuation estimate can be presented to the requesting user in any text or graphic format suitable for displaying the valuation estimate to a user. For example, the representation of the data valuation estimate could be a numeric score which could, in one embodiment, be displayed using a graphical meter. Alternatively or additionally, the representation of the data valuation estimate could be presented a bar graph displaying an earnings estimate over time.

Other embodiments of the process 600 described above are possible. For example, some embodiments could bypass the need for user interaction via a user interface. For example, requests for data valuation could be submitted to the system in a batched file or set of transactions, via an email, or via a voice call, and data valuation estimates could be transmitted back to the requesting user as a batched file or set of transactions, via an email, or via a voice call.

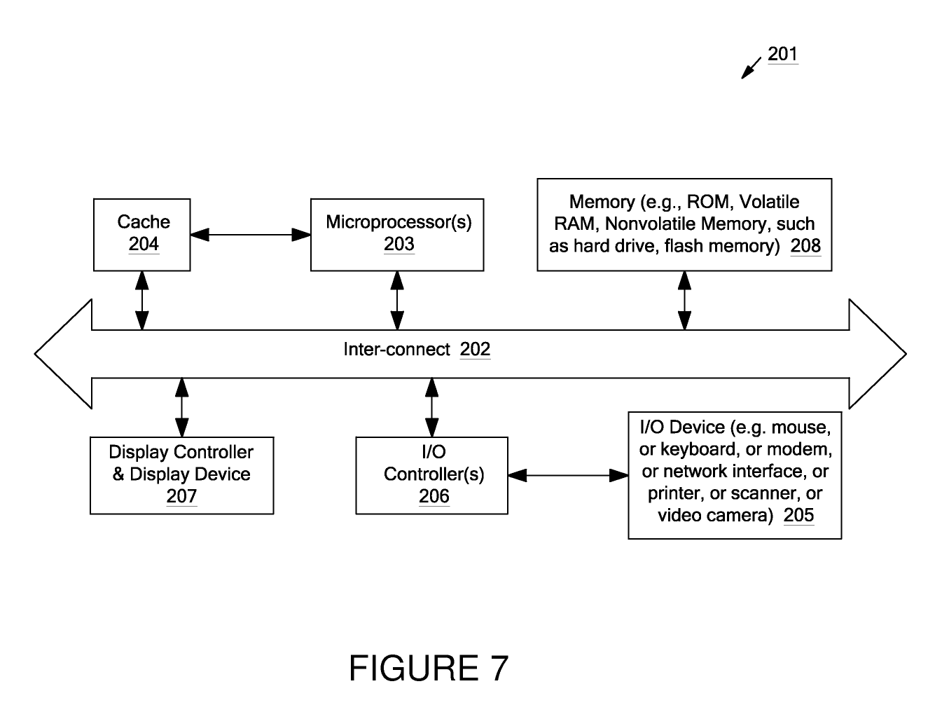

FIG. 7 shows a block diagram of a data processing system which can be used in various embodiments (e.g., to implement online marketplace 123 or service provider website 158 or 170). While FIG. 7 illustrates various components of a computer system, it is not intended to represent any particular architecture or manner of interconnecting the components. Other systems that have fewer or more components may also be used.

In FIG. 7, the system 201 includes an inter-connect 202 (e.g., bus and system core logic), which interconnects a microprocessor(s) 203 and memory 208. The microprocessor 203 is coupled to cache memory 204 in the example of FIG. 6.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices which are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 6 is used to implement an online website and/or other servers. In one embodiment, a data processing system as illustrated in FIG. 7 is used to implement an end user device (e.g., end user device 145) or a data buyer device (e.g., data buyer device 141 or 143). A user device may be in the form of a personal digital assistant (PDA), a client mobile device, a cellular phone, a notebook computer or a personal desktop computer.

In some embodiments, one or more servers of the system can be replaced with the service of a peer to peer network of a plurality of data processing systems, or a network of distributed computing systems, or a network cloud. The peer to peer network, distributed computing system, or cloud, can be collectively viewed as a server data processing system.

Embodiments of the disclosure can be implemented via the microprocessor(s) 203 and/or the memory 208. For example, the functionalities described can be partially implemented via hardware logic in the microprocessor(s) 203 and partially using the instructions stored in the memory 208. Some embodiments are implemented using the microprocessor(s) 203 without additional instructions stored in the memory 208. Some embodiments are implemented using the instructions stored in the memory 208 for execution by one or more general purpose microprocessor(s) 203. Thus, the disclosure is not limited to a specific configuration of hardware and/or software.

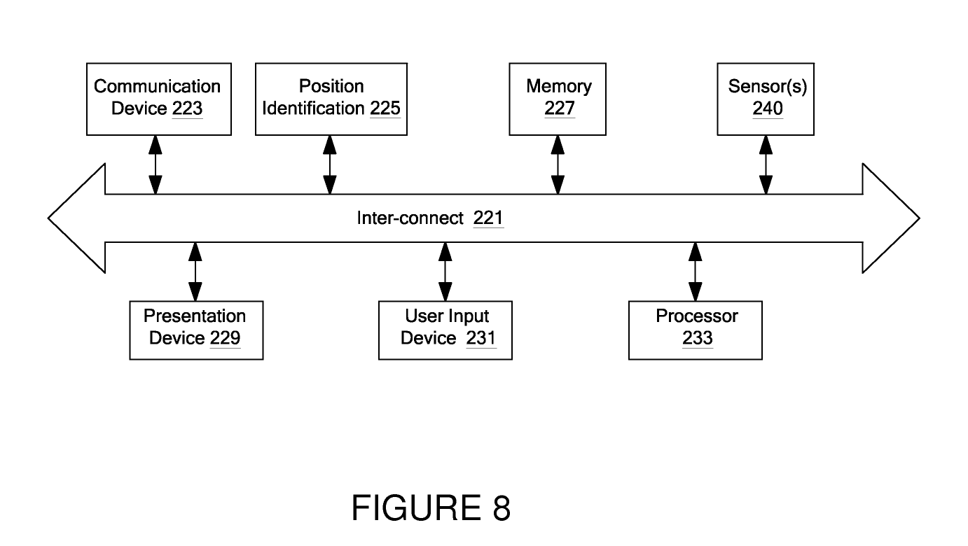

FIG. 8 shows a block diagram of a user device according to one embodiment. In FIG. 8, the user device includes an inter-connect 221 connecting the presentation device 229, user input device 231, a processor 233, a memory 227, a position identification unit 225, a communication device 223, and one or more sensors 240 (e.g., used to collect the user data discussed above). Sensors 240 may alternatively be located in a separate sensing platform or device that communicates (e.g., wirelessly) with the user device. The user device may be used to implement data buyer device 141, 143 and/or end user device 145.

In FIG. 8, the position identification unit 225 is used to identify a geographic location for associated collected user data with a location. The position identification unit 225 may include a satellite positioning system receiver, such as a Global Positioning System (GPS) receiver, to automatically identify the current position of the user device. Alternatively, an interactive map can be displayed to the user; and the user can manually select a location from the displayed map.

In FIG. 8, the communication device 223 is configured to communicate with an online marketplace to provide user data. In one embodiment, the user input device 231 is configured to generate user data which is to be tagged with the navigation information. The user input device 231 may include a text input device, a still image camera, a video camera, and/or a sound recorder, etc. In one embodiment, the user input device 231 and the position identification unit 225 are configured to automatically tag the user data collected with the navigation information identified by the position identification unit 225.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Additional other embodiments may include the following methods, machine readable mediums, and systems (numbered below merely for ease of reference). In embodiment number 1 below, a trading system is used to sell data (collected from end users or sellers) selected by a data buyer (or buyer) from various data categories in a data taxonomy presented to the buyer in a data trading marketplace. The marketplace may be implemented using a data processing system as described herein. The data traded on the marketplace may be sets of data (e.g., data reports or other data sets).

What is claimed is:

1. A method, comprising:
receiving, over a network, from a requesting user, a request for a valuation of a data set;
identifying, using a data processing system, a plurality of valuation elements associated with the data set;
determining, using the data processing system, a data valuation estimate for the data set using the plurality of valuation elements; and
transmitting, over the network, to the requesting user, a representation of the data valuation estimate such that the representation of the data valuation estimate is caused to be displayed on a display device associated with the requesting user.

2. The method of claim 1, wherein the plurality of valuation elements comprise a set of n+1 elements, numbered 0 to n, and the valuation estimate, V, is determined using the equation:
V=ƒ[(x₀,v₀),(x₁,v₁),(x₂,v₂) . . . (xₙ,vₙ)]
where
V is a valuation estimate,
ƒ is a valuation function
xₙ is a weighting factor for each contributing element n and
vₙ is a value for each contributing element.

3. The method of claim 2, wherein the valuation function ƒ is a linear equation of a form such that:
V=(x₀*v₀)+(x₁*v₁)+(x₂*v₂) . . . (xₙ*vₙ)

4. The method of claim 1, wherein the representation of the data valuation estimate is a numeric score displayed as a graphical meter.

5. The method of claim 1, wherein the representation of the data valuation estimate is a bar graph displaying an earnings estimate over time.

6. The method of claim 1, wherein the requesting user is a data buyer and the data set is a data set uploaded to a data marketplace by a data seller.

7. The method of claim 1, wherein the requesting user is a data seller and the data set is a data set uploaded to a data marketplace by a data seller.

8. The method of claim 1, wherein the requesting user is a data seller and the data set is a data set located on a computing system controlled by the data seller.

9. The method of claim 2, wherein at least some of the plurality of valuation elements associated with the data set are data seller data elements.

10. The method of claim 9, wherein the data seller data elements are selected from at least one of the list: age of a data seller's account in a data marketplace, completeness of data in the data seller's data in the data marketplace, frequency of and consistency of the data seller's data in the data marketplace, a number of sources in the data seller's data in the data marketplace, variety and diversity of data sources in the data seller's data in the data marketplace, a frequency of inclusion of the data seller's data in a data marketplace reports, participation of the data seller in social networks, comparison of data seller's data with standardized population data relative to mean and standard deviation of standardized population, and correlation of data seller's data with external events.

11. The method of claim 2, wherein at least some of the plurality of valuation elements associated with the data set are data buyer data elements.

12. The method of claim 11, wherein the data buyer data elements are selected from at least one of the list: information in a data buyer's account in a data marketplace, a market segment the data set relates to, frequency of and consistency of the data seller's data in the data marketplace, a pricing schedule for the data set, and a purchase history for the data buyer.

13. The method of claim 2, wherein at least some of the plurality of valuation elements associated with the data set are data marketplace data elements.

14. The method of claim 13, wherein the data marketplace data elements are selected from at least one of the list: a total sales of data within a data marketplace in a market segment, a velocity of sales within the data marketplace in the market segment, a total number of data records within the data marketplace in the market segment, a total amount of data within the data marketplace in the market segment, and a frequency of market segment selection by buyers.

15. The method of claim 2, wherein at least some of the plurality of valuation elements associated with the data set are external market segment data elements.

16. The method of claim 15, wherein the external market segment data elements are selected from at least one of the list: an external market segment size, a value of the external market segment, a relation to indexes for the external market segment, news connected with the market segment, and the seasonality of the market segment.

17. The method of claim 2, wherein at least one of the plurality of valuation elements associated with the data set are social-networking data elements.

18. The method of claim 17, wherein the social-networking data elements are selected from at least one of the list: a number of new users of a data marketplace a current user brings in by referral and invitation, a number of additional users of a data marketplace registered by the new users, and an amount of data uploaded by the new users and the additional users.

19. The method of claim 2, wherein at least some of the plurality of valuation elements associated with the data set are privacy risk data elements.

20. The method of claim 19, wherein the privacy risk data elements are selected from at least one of the list: a persona privacy risk to a data seller associated with the data set, an identity privacy risk to the data seller associated with the data set, and a total privacy risk for data sellers.

21. A data processing system, comprising:
memory to store a plurality of data sets corresponding to a plurality of sellers; and
at least one processor configured to:
receive, over a network, from a requesting user, a request for a valuation of a data set;
identify a plurality of valuation elements associated with the data set;
determine a data valuation estimate for the data set using the plurality of valuation elements; and
transmit, over the network, to the requesting user, a representation of the data valuation estimate such that the representation of the data valuation estimate is caused to be displayed on a display device associated with the requesting user.

22. A non-transitory machine readable storage medium embodying instructions, the instructions causing a data processing system to perform a method, the method comprising:
receiving, from a requesting user, a request for a valuation of a data set;
identifying a plurality of valuation elements associated with the data set;
determining a data valuation estimate for the data set using the plurality of valuation elements; and
transmitting, to the requesting user, a representation of the data valuation estimate such that the representation of the data valuation estimate is caused to be displayed on a display device associated with the requesting user.
